(19) United States
(12) Patent Application Publication
(10) Pub. No.: US 2013/0007987 A1
(43) Pub. Date: Jan. 10, 2013

(54) Handle Gripping Device

(76) Inventors: Kathleen J. Kleindorfer, Phoenix, AZ (US); Harold Deloach, Glendale, AZ (US)

(21) Appl. No.: 13/177,009

(22) Filed: Jul. 6, 2011

(51) Int. Cl. B25G 1/10; B25G 1/00; A47G 29/10

(52) U.S. Cl. 16/421; 16/431; 70/456 R

(57) ABSTRACT

A handle gripping device comprising a backing, where the backing encompasses an entire back surface of the handle gripping device; a pair pockets attached to the backing, where the pair of pockets are separated with a center portion of the backing; a pair of openings on the pair of opposing pockets, where the pair of openings face each other to accept a hand of a user; a thermal absorbing layer against a backside of the backing, where the thermal absorbing layer provides a thermal absorbing layer to enable the user to grasp a vehicle handle, and to protect the hand from an extreme temperature of the vehicle handle; and a keychain attached to the backing, wherein the keychain enables the user to attach the handle gripping device to a set of keys.

### BACKGROUND OF THE INVENTION

1. Field of the Invention

The present invention relates to hand cover to enable a user to protect a user's hand when opening a vehicle's door.

2. Description of Related Art

Many developments have been made to protect or to shield a person's hands from potentially hazardous materials, temperatures or textures. For example, work gloves, potholders and mittens are all used to guard the person's hands, skin and fingers. The hand protectors place a barrier between the hands and the external environment to prevent temporary discomfort or even permanent damage. The hand protectors may be items such as latex gloves which protect both a patient and a doctor from the spread of bacteria, or alternatively mittens to protect a skier's hands from the frigid temperatures of ice and snow. While the shape, form and coverage of the hand protectors vary widely, they all serve a unifying purpose: to guard the hands from harm or damage.

Presently, there are many hand coverings that protect the user's hands from heat. For example, U.S. Pat. No. 6,305,023 by Donna J. Barkes discloses a premium oven mitt/hot pad wherein a square shaped oven mitt utilizes a flap to protect the user's wrist. The mitt allows the user to handle items that are very hot and prevents the user's skin from burning when exposed to the high temperatures. Alternatively, U.S. Pat. No. 4,628,544 by Joyce A. Erickson discloses a server gauntlet wherein a mitt-like member covers a user's hand and forearm. An auxiliary pad is included as a simple rectangular hot pad to assist the mitt when lifting and transporting a hot item. Finally, U.S. Pat. No. 4,751,747 by Janice Banks and Mark Bradford discloses a finger and thumb heat protector wherein a three-pocket covering is provided to protect the user's thumb, index finger and middle finger. The finger and thumb heat protector allows the user to manipulate hot objects without covering the entire hand.

While these devices to provide the user with heat protection from hot objects they are specifically designed for use with either cooking or hair dressing. Another surface that commonly becomes heated is a vehicle, specifically the vehicle handle. Many persons have experienced the burning sensation felt when trying to open a hot car door. The person must either try to pull the handle quickly enough to not experiencing much pain, or place a garment piece over their hand to grasp the handle. Since most people do not typically carry potholders in their vehicle the person is left without a way to safely pull the door handle.

Therefore, it would be desirable in the art to provide a hand covering that protects a user's hand when opening the door of a hot vehicle. It would also be beneficial in the art to provide a means to easily transport the hand cover so that it is readily available for use.

### SUMMARY OF THE INVENTION

In view of the foregoing disadvantages inherent in the prior art, the general purpose of the present invention is to provide a handle gripping device, configured to include all of the advantages of the prior art, and to overcome the drawbacks inherent therein.

Accordingly, an object of the present invention is to provide a handle gripping device that protects a user's hand when they grasp and hold a heated vehicle handle.

Another object of the present invention is to provide a handle gripping device that attaches to a user's key ring so that the device is readily available.

To achieve the above objects, in an aspect of the present invention, a handle gripping device is disclosed comprising a backing, where the backing encompasses an entire back surface of the handle gripping device; a pair pockets attached to the backing, where the pair of pockets are separated with a center portion of the backing; a pair of openings on the pair of opposing pockets, where the pair of openings face each other to accept a hand of a user; a thermal absorbing layer against a backside of the backing, where the thermal absorbing layer provides a thermal absorbing layer to enable the user to grasp a vehicle handle, and to protect the hand from an extreme temperature of the vehicle handle; and a keychain attached to the backing, wherein the keychain enables the user to attach the handle gripping device to a set of keys.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a top view of a handle gripping device in accordance with an exemplary embodiment of the present invention;

FIG. 2 depicts a bottom view of a handle gripping device in accordance with an exemplary embodiment of the present invention; and

FIG. 3 depicts a side view of a handle gripping device in accordance with an exemplary embodiment of the present invention.

Like reference numerals refer to like parts throughout the description of several views of the drawings.

### DETAILED DESCRIPTION OF THE DRAWINGS

The present invention relates to hand cover to enable a user to better grip a handle and to protect the user's hand during circumstances when the handle is very hot or very cold. The present invention provides a handle gripping device to protect the user's hand when opening a door. The handle gripping device includes a backing with two opposing pockets wherein the user may slide two fingers into one pocket and their thumb into the opposing pocket. With their fingers and palm covered, the user may then easily grasp a vehicle handle without burning their fingers or thumb. The handle gripping device may be transported by connecting it to a set of keys with a key ring. This way the user is never without protection for their hands when opening their vehicle.

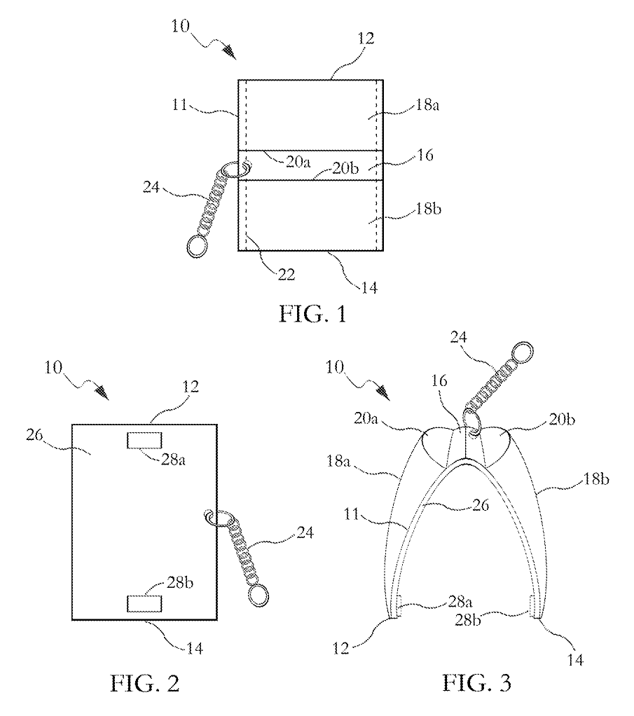

Tuning now descriptively to the drawings, referring to FIG. 1, a top view of a handle gripping device (10) is shown in accordance with an exemplary embodiment of the present invention. The handle gripping device (10) includes a backing (11) to encompass the entire back surface of the handle gripping device (10). The backing (11) includes a first edge (12) at a top portion of the handle gripping device (10) and a second edge (14) at a bottom portion of the handle gripping device (10). Between the first edge (12) and the second edge (14) is a center portion (16). During use, the backing (11) folds along the center portion (16) to enable the first edge (12) and the second edge (14) to touch.

The center portion (16) of the backing (11) is positioned between a pair of opposing pockets (18a, 18b) to create a space between the pair of pockets (18a, 18b). The pair of pockets (18a, 18b) includes a pair of openings (20a, 20b), where the pair of openings (20a, 20b) face each other, to receive a user's fingers and thumb. Along the lateral edges of the handle gripping device (10) may be a seam (22). The seam (22) closes the pair of pockets (18a, 18b) along the outer edges perpendicular to the first edge (12) and the second edge (14). The openings (20a, 20b) and the pockets (18a, 18b) are large enough to allow the user to easily slide their fingers inside and to manipulate the backing (11).

During use, the user may place 1-2 of their fingers into a first pocket (18a) and their thumb into a second pocket (18b). The handle gripping device (10) may be specifically designed so that the user's index and middle fingers slide into the first pocket (18a) and the user's thumb slides into the second pocket (18b). With their fingers in the pockets (18a, 18b) the user may easily open and close their hand to move the first edge (12) and the second edge (14) towards and away from each other folding along the center portion (16). Likewise, the user may close the handle gripping device (10) around a door handle to provide a layer of protection between the user's hand and the extreme temperature of the handle.

Attached to a lateral edge of the center portion is a keychain (24). The keychain (24) enables the handle gripping device (10) to attach to a set of keys. By attaching the handle gripping device (10) the keys the user ensures that hand protection from hot or cold door handles is readily available.

Referring now to FIG. 2, a bottom view of the handle gripping device (10) is shown in accordance with an exemplary embodiment of the present invention. The entire bottom side of the backing (11) is covered by a thermal absorbing layer (26). The thermal absorbing layer (26) may simply be the backside of the backing (11) or alternatively it may be a separate material layer attached to the backside of the backing (11). The thermal absorbing layer (26) is a layer of material that protects the user's hand from feeling the temperature of the door handle. In one particular embodiment, the thermal absorbing layer (26) may be made from soft leather. The thermal absorbing layer (26) may be covered with a textured surface made of materials like rubber or plastic to provide a better, more secure grip on the handle. When the gripping device is made from soft leather, a single layer of material may be used.

Along the first edge (12) and the second edge (14) are a fastening means (28a, 28b). The fastening means (28a, 28b) may be a hook and loop fastener (more commonly known as Velcro®), a snap, a tie and the like. The fastening means (28a, 28b) secure the first edge (12) and the second edge (14) together when the handle gripping device (10) is not in use. This way when the key chain (24) is attached to the key ring the handle gripping device (10) is in a compact or folded form so that it takes up less space and does not interfere with the keys on the ring. In an alternative embodiment, the gripping device (10) may be designed with any fastening means to provide more convenient use.

Referring to FIG. 3, a side view of the handle gripping device (10) is shown in accordance with an exemplary embodiment of the present invention. The handle gripping device (10) is illustrated to better view the pair of pockets (18a, 18b) and the openings (20a, 20b). The user simply slides their fingers and thumb into the openings (20a, 20b) and then uses the handle gripping device (10) to grasp a vehicle handle. The thermal absorbing layer (26) comes into contact with the either hot or cold outer surface of the vehicle handle and serves as a layer of protection and insulation between the user's hand and the handle. Whether the handle is excessively hot or excessively cold, when the user wears the handle gripping device (10) the user's hand is not discomforted or injured trying to open their vehicles.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A handle gripping device comprising:
a backing, where said backing encompasses an entire back surface of said handle gripping device;
a pair pockets attached to said backing, where said pair of pockets are separated with a center portion of said backing;
a pair of openings on said pair of pockets, where said pair of openings face each other to accept a hand of a user;
a thermal absorbing layer against a backside of said backing, where said thermal absorbing layer provides a thermal absorbing layer to enable said user to grasp a vehicle handle; and
a keychain attached to said backing, wherein said keychain enables said user to attach said handle gripping device to a set of keys.

2. The handle gripping device according to claim 1, wherein said thermal absorbing layer is made of leather.

3. The handle gripping device according to claim 1, wherein said thermal absorbing layer is covered with a textured surface to provide a better grip for said user.

4. The handle gripping device according to claim 1, wherein said thermal absorbing layer is a separate material layer from said backing.

5. The handle gripping device according to claim 1, wherein said pair of pockets are closed on the lateral sides with a seam.

6. The handle gripping device according to claim 1, wherein said keychain is attached to a lateral portion of said center portion.

7. The handle gripping device according to claim 1, wherein said thermal absorbing layer includes a fastening means to secure said first edge and said second edge together.

8. The handle gripping device according to claim 7, wherein said fastening means is a hook and loop fastener.

9. The handle gripping device according to claim 1, wherein said pair of pockets enables said user to place an index finger and a middle finger into a first pocket and a thumb into a second pocket.

10. The handle gripping device according to claim 1, wherein said handle gripping device folds along said center portion to grasp said vehicle handle.

11. A handle gripping device comprising:
a backing, where said backing encompasses an entire back surface of said handle gripping device;
a pair pockets attached to said backing, where said pair of pockets are separated with a center portion of said backing; and
a pair of openings on said pair of pockets, where said pair of openings face each other to accept a hand of a user.
